(19) United States
(12) Patent Application Publication
(10) Pub. No.: US 2023/0112534 A1
(43) Pub. Date: Apr. 13, 2023

(54) ARTIFICIAL INTELLIGENCE PLANNING METHOD AND REAL-TIME RADIO ACCESS NETWORK INTELLIGENCE CONTROLLER

(71) Applicant: Wistron Corporation, New Taipei City (TW)

(72) Inventor: Chih-Ming Chen, New Taipei City (TW)

(73) Assignee: Wistron Corporation, New Taipei City (TW)

(21) Appl. No.: 17/721,352

(22) Filed: Apr. 14, 2022

(30) Foreign Application Priority Data
Oct. 13, 2021 (TW) 110137963
Mar. 9, 2022 (TW) 111108574

(51) Int. Cl. G06N 7/00; H04W 24/02

(52) U.S. Cl. CPC G06N 7/005; H04W 24/02

(57) ABSTRACT

An artificial intelligence planning method and a real-time radio access network intelligence controller are provided. The method includes: obtaining current input data; predicting a prediction result based on the current input data by using a causal reasoning model; generating a current state at least based on the prediction result; treating the current state as an initial state of an artificial intelligence planner and finding a specific planning path in a planning tree based on the initial state by using the artificial intelligence planner; and controlling a target system based on a plurality of action instructions.

### CROSS-REFERENCE TO RELATED APPLICATION

This application claims the priority benefit of Taiwan application serial no. 110137963, filed on Oct. 13, 2021 and Taiwan application serial no. 111108574, filed on Mar. 9, 2022. The entirety of each of the above-mentioned patent applications is hereby incorporated by reference herein and made a part of this specification.

### BACKGROUND

### Technical Field

The disclosure relates to an artificial intelligence (AI) technology, and in particular, relates to an artificial intelligence planning method and a real-time radio access network intelligence controller.

### Description of Related Art

In the open radio access network (O-RAN), a non-real-time RAN intelligent controller (non-RT RIC) and a near-RT RIC are defined. The delay of the non-RT RIC is greater than 1 second, while the delay of the near-RT RIC is between 1 millisecond and 1 second.

However, no RT RIC (with less than 1 millisecond latency) that can operate at the cell site is defined in O-RAN.

### SUMMARY

Accordingly, the disclosure provides an artificial intelligence planning method and a real-time radio access network intelligence controller configured to solve the foregoing technical problems.

The disclosure provides an artificial intelligence planning method, and the method includes the following steps. Current input data is obtained. A prediction result is predicted based on the current input data by using a causal reasoning model. A current state is generated at least based on the prediction result. The current state is treated as an initial state of an artificial intelligence planner, and a specific planning path is found in a planning tree based on the initial state by using the artificial intelligence planner. The specific planning path includes a plurality of action instructions. A target system is controlled based on the plurality of action instructions.

The disclosure further provides real-time radio access network intelligence controller including a storage circuit and a processor. The storage circuit stores a program code. The processor is coupled to the storage circuit and accesses the program code to perform the following operations. The processor obtains current input data. The processor predicts a prediction result based on the current input data by using a causal reasoning model. The processor generates a current state at least based on the prediction result. The processor treats the current state as an initial state of an artificial intelligence planner and finds a specific planning path in a planning tree based on the initial state by using the artificial intelligence planner. The specific planning path includes a plurality of action instructions. The processor controls a target system based on the plurality of action instructions.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram illustrating an artificial intelligence planning device according to an embodiment of the disclosure.

FIG. 1B is a schematic diagram illustrating an artificial intelligence planning system according to an embodiment of the disclosure.

FIG. 2 is a schematic flow chart illustrating an artificial intelligence planning method according to an embodiment of the disclosure.

FIG. 3 is a schematic diagram illustrating planning node sets of a plurality of planning layers according to an embodiment of the disclosure.

FIG. 4 is a schematic diagram illustrating estimation of a fitness score corresponding to an i^{th} planning layer according to an embodiment of the disclosure.

FIG. 5 is a schematic diagram illustrating a planning tree corresponding to a code layer according to an embodiment of the disclosure.

FIG. 6 is a schematic flow chart illustrating an artificial intelligence planning method according to an embodiment of the disclosure.

FIG. 7A is a schematic diagram illustrating an open radio access network (O-RAN) architecture according to an embodiment of the disclosure.

FIG. 7B is a schematic diagram illustrating a real-time RAN intelligent controller (RT RIC) according to FIG. 7A.

FIG. 8 is a schematic flow chart illustrating an artificial intelligence planning method according to an embodiment of the disclosure.

FIG. 9 is a schematic diagram illustrating generation of a prediction result according to an embodiment of the disclosure.

FIG. 10 is a schematic diagram illustrating bandwidth calendaring for a radio unit (RU) according to FIG. 1B.

### DESCRIPTION OF THE EMBODIMENTS

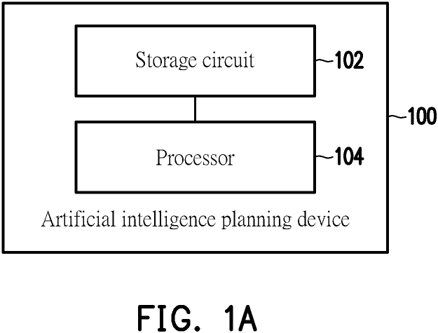

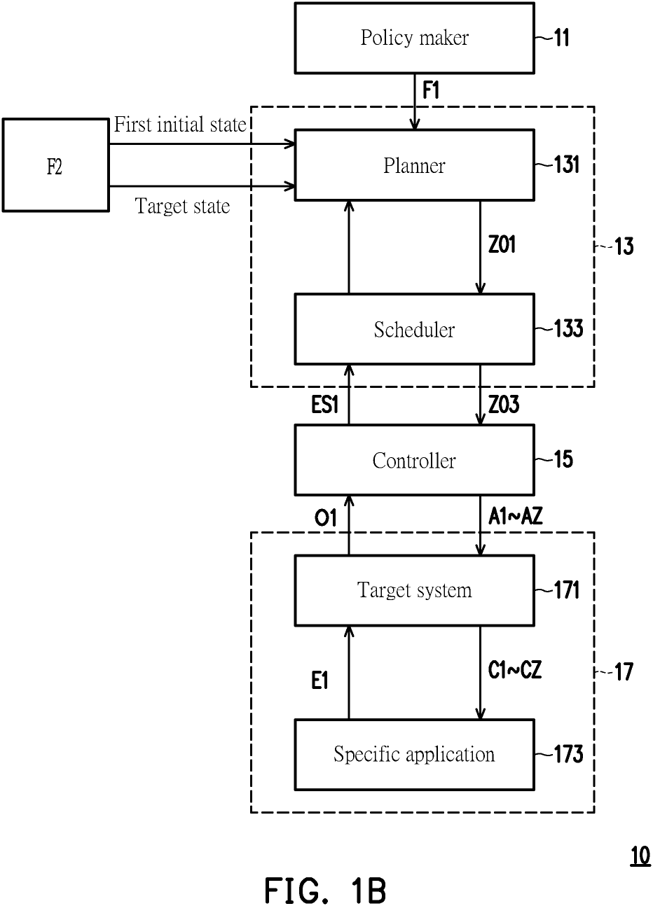

With reference to FIG. 1A and FIG. 1B, FIG. 1A is a schematic diagram illustrating an artificial intelligence planning device according to an embodiment of the disclosure, and FIG. 1B is a schematic diagram illustrating an artificial intelligence planning system according to an embodiment of the disclosure.

In different embodiments, an artificial intelligence planning device 100 in FIG. 1A may be various types of intelligent devices, computer devices, and/or servers, but it is not limited thereto. In different embodiments, the artificial intelligence planning device 100 in FIG. 1A may be deployed on an application side, an edge cloud, and/or the cloud.

As shown in FIG. 1A, the artificial intelligence planning device 100 includes a storage circuit 102 and a processor 104. The storage circuit 102 is a fixed or a movable random access memory (RAM) in any form, a read-only memory (ROM), a flash memory, a hard disc, other similar devices, or a combination of the foregoing devices, for example, and may be used to record a plurality of program codes or modules.

The processor 104 is coupled to the storage circuit 102 and may be a processor for general use, a processor for special use, a conventional processor, a digital signal processor, a plurality of microprocessors, one or a plurality of microprocessors combined with a digital signal processor core, a controller, a microcontroller, an application specific integrated circuit (ASIC), a field programmable gate array (FPGA) circuit, an integrated circuit of any other types, a state machine, a processor based on an advanced RISC machine (ARM), and the like.

As shown in FIG. 1B, the artificial intelligence planning system 10 may include an artificial intelligence planner (AI planner) 13, a controller 15, and a target server 17. In some embodiments, the target server 17 may be an MEC server, which may include an illustrated target system 171 (e.g., an MEC system), and a specific application 173 may run on the target server 17.

In the embodiments of the disclosure, the processor 104 may access the modules and program codes recorded in the storage circuit 102 to implement the functions and operations provided by the artificial intelligence planner 13/controller 15 in FIG. 1B, and description thereof is provided in detail in the following paragraphs.

Generally, the work of converting a user requirement into a software requirement specification (SRS) is performed manually. One user requirement may be converted into one or a plurality of technical requirements in the SRS. However, after the SRS is obtained, an architecture, a design, and coding of a target application are automatically adjusted by AI most of the time. For ease of description, in the following paragraphs, it is assumed that the target application is the specific application 173 in FIG. 1B, but it is not limited thereto.

In the technical requirements of the SRS, a functional requirement and a non-functional requirement may be included. In the functional requirement, a function may be presented by a combination of an input, a behavior, and an output. The functional requirement may be computation, technical details, data processing, or other content that describes the function expected to be achieved by the system. The “behavior” herein may be represented by a control flow graph, a data flow graph, a call graph, and a constraint graph.

The non-functional requirement imposes restrictions on design and implementation, such as maintainability, extensibility, simplicity, understandability, re-usability, performance, etc., and these restrictions may be called as metrics.

In some embodiments, the control flow graph, data flow graph, call graph, and constraint graph in the functional requirement may be used to describe a corresponding partial program architecture (which may be understood as an architecture of the specific application 173), and a mapping relationship may be presented as a formula of “(control flow graph, data flow graph, call graph, constraint graph) --> architecture pattern”. That is, a tuple of one functional requirement may be mapped to an architecture pattern.

Similarly, the control flow graph, data flow graph, call graph, and constraint graph in the functional requirement may also be used to describe a corresponding partial program design and coding (which may be understood as a design and coding of the specific application 173), and the mapping relationships may be respectively presented as “(control flow graph, data flow graph, call graph, constraint graph) --> design pattern” and “(control flow graph, data flow graph, call graph, constraint graph) --> code pattern”. That is, the tuple of one functional requirement may be mapped to a design pattern and a code pattern.

In an embodiment, the technical requirement in the SRS may be treated as a goal of a planner 131 in the artificial intelligence planner 13. In an embodiment, a policy maker 11 may generate a domain file F1 in a problem domain independent heuristic method based on a planning domain definition language (PDDL) and inputs the domain file F1 to the planner 131.

Generally, content of a conventional domain file with only a single planning layer usually includes one description segment, and the description segment may include a plurality of description sentences listed as examples as follows:

precond_1->action_1->effect_1 precond_2->action_2->effect_2 ...... precond_n->action_n->effect_n,

where the meaning of each description sentence is “entering a result state effect_i after a pre-state precond_i executes a specific action command action_i”.

In the embodiments of the disclosure, a specific application 173 may include N planning layers, where N is a positive integer. For ease of description, in the following, it is assumed that the specific application 173 may include three planning layers (that is, N is 3): an architecture layer, a design layer, and a code layer, but it is only used as an example and is not intended to limit possible implementation of the disclosure. In other embodiments, a designer may adjust the numerical value of N according to needs, and the numerical value of N is not limited to the example provided above.

Correspondingly, in the embodiments of the disclosure, the domain file F1 may include N description segments corresponding to the N planning layers (i.e., the architecture layer, the design layer, and the code layer). In this case, the domain file F1 may have content as exemplified below.

[architecture] precond_arch_1->action_arch_1->effect_arch_1 precond_arch_2->action_arch_2->effect_arch_2 ...... precond_arch_n->action_arch_n->effect_arch_n

[design] precond_desn_1->action_desn_1->effect_desn_1 precond_desn_2->action_desn_2->effect_desn_2 ...... precond_desn_n->action_desn_n->effect_desn_n

[code]
precond_code_1->action_code_1->effect_code_1 precond_code_2->action_code_2->effect_code_2 ...... precond_code_n->action_code_n->effect_code_n

In an embodiment, the action_arch_i belonging to the architecture layer may include “add architecture pattern” and “remove architecture pattern”. Further, “state effect_arch_i” refers to an architecture pattern set which is formed after adding/removing a system. In some embodiments, if the technical requirement is adjusted, a new architecture pattern may be added after an old architecture pattern is removed.

Similarly, the action_desn_i belonging to the design layer may include “add design pattern” and “remove design pattern”. Further, “state effect_desn_i” refers to a design pattern set after adding/removing a system. In some embodiments, if the technical requirement is adjusted, a new design pattern may be added after an old design pattern is removed.

The action_code_i belonging to the code layer may include “add code pattern” and “remove code pattern”. Further, “state effect_code_i” refers to a code pattern set after adding/removing a system. In some embodiments, if the technical requirement is adjusted, a new code pattern may be added after an old code pattern is removed.

In addition, in the embodiments of the disclosure, an effect generated by the “add code pattern” is, for example, adding a piece of program code to a program code of the specific application 173, and an effect generated by the “remove code pattern” is, for example, removing a piece of program code from the program code of the specific application 173. In an embodiment, neither the add/remove architecture pattern nor the add/remove design pattern may have any substantial impact on the program code of the specific application 173, and only the add/remove code pattern” may have the abovementioned substantial impact on the program code of the specific application 173.

In the embodiments of the disclosure, in addition to obtaining the domain file F1 associated with the specific application 173, the planner 131 may also obtain a problem file F2 associated with the specific application 173. The problem file F2 may indicate a first initial state and a target state of each of the planning layers of the specific application 173.

In response to the domain file F1 and the problem file F2, artificial intelligence planner 13 executed by the processor 104 may correspondingly execute an artificial intelligence planning method provided by the disclosure, and details thereof are described as follows.

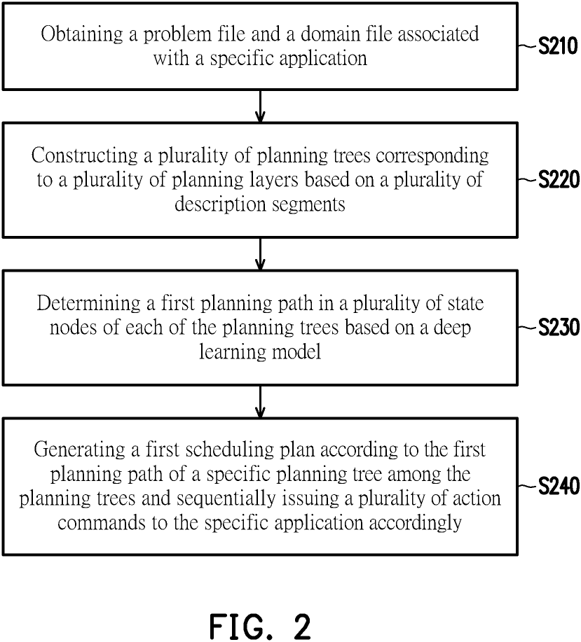

With reference to FIG. 2, which is a schematic flow chart illustrating an artificial intelligence planning method according to an embodiment of the disclosure. The method provided by this embodiment may be implemented by the artificial intelligence planner 13 of FIG. 1B executed by the processor 104 of FIG. 1A, and each step in FIG. 2 is described in detail together with the elements shown in FIG. 1B.

First, in step S210, the planner 131 in the artificial intelligence planner 13 obtains the problem file F2 and the domain file F1 associated with the specific application 173. Herein, the domain file F1 includes the N description segments (e.g., the [architecture], [design], and [code] mentioned in the foregoing paragraphs) of the N planning layers (i.e., the architecture layer, design layer, and code layer) corresponding to the specific application 173, and the problem file F2 may indicate the first initial state and the target state of each of the planning layers.

Next, in step S220, the planner 131 in the artificial intelligence planner 13 construct N planning trees corresponding to the planning layers based on the description segments.

In an embodiment, each of the planning trees has a plurality of state nodes and corresponds to one of the planning layers. That is, in the case that the specific application 173 has the architecture layer, design layer, and code layer, the planner 131 may construct 3 planning trees corresponding to the architecture layer (which may be understood as a 1st planning layer), the design layer (which may be understood as a 2nd planning layer), and the code layer (which may be understood as a 3rd planning layer) based on the 3 description segments in the domain file F1, and each of the planning trees may include multiple state nodes.

Further, each of the planning layers has a planning node set, and the planning node set of each of the planning layers may include a plurality of planning nodes.

In an embodiment, the N description segments in the domain file F1 may include an i^{th} description segment (i is an index value, and N > i ≥ 1) corresponding to an i^{th} planning layer among the N planning layers. Further, the i^{th} description segment may include a plurality of first description sentences corresponding to the i^{th} planning layer, and each of the first description sentences is expressed as “precond_i ->action_i->effect_i”. In an embodiment, precond_i is a pre-state, action_i is a specific action command, and effect_i is a result state which may be achieved by executing the specific action command in the pre-state.

In an embodiment, action_i includes adding a node to the planning nodes of the i^{th} planning layer or removing a node from the planning nodes of the i^{th} planning layer. Further, effect_i is the planning node set formed by the planning nodes of the i^{th} planning layer after the specific action command is executed in the pre-state.

Further, the N description segments in the domain file F1 may include an N^{th} description segment corresponding to an N^{th} planning layer among the N planning layers, the N^{th} description segment includes a plurality of description sentences corresponding to the N^{th} planning layer, and each of the description sentences is expressed as: “precond_N ->action_N->effect_N”, where precond_N is a pre-state, action_N is a specific action command, and effect_N is a result state which may be achieved by executing the specific action command in the pre-state.

In an embodiment, action _N includes adding a node to the planning nodes of the N^{th} planning layer or removing a node from the planning nodes of the N^{th} planning layer, and effect_N is the planning node set formed by the planning nodes of the N^{th} planning layer after the specific action command is executed in the pre-state.

Based on the above, when i is 1, the corresponding description segment may be understood as the content of [architecture] in the domain file F1. When i is 2, the corresponding description segment may be understood as the content of [design] in the domain file F1. When i is 3, the corresponding description segment may be understood as the content of [code] in the domain file F1.

In this case, the previously-mentioned action_arch_i may be understood as including adding a planning node to or removing a planning node from the planning node set corresponding to architecture layer. Correspondingly, effect_arch_i may be understood as the planning node set formed by the planning nodes corresponding to the architecture layer. Further, action_desn_i may be understood as including adding a planning node to or removing a planning node from the planning node set corresponding to design layer, and action_code_i may be understood as including adding a planning node to or removing a planning node from the planning node set corresponding to code layer. In this case, effect_desn_i may be understood as the planning node set formed by the planning nodes corresponding to the design layer, and effect_code_i may be understood as the planning node set formed by the planning nodes corresponding to the code layer.

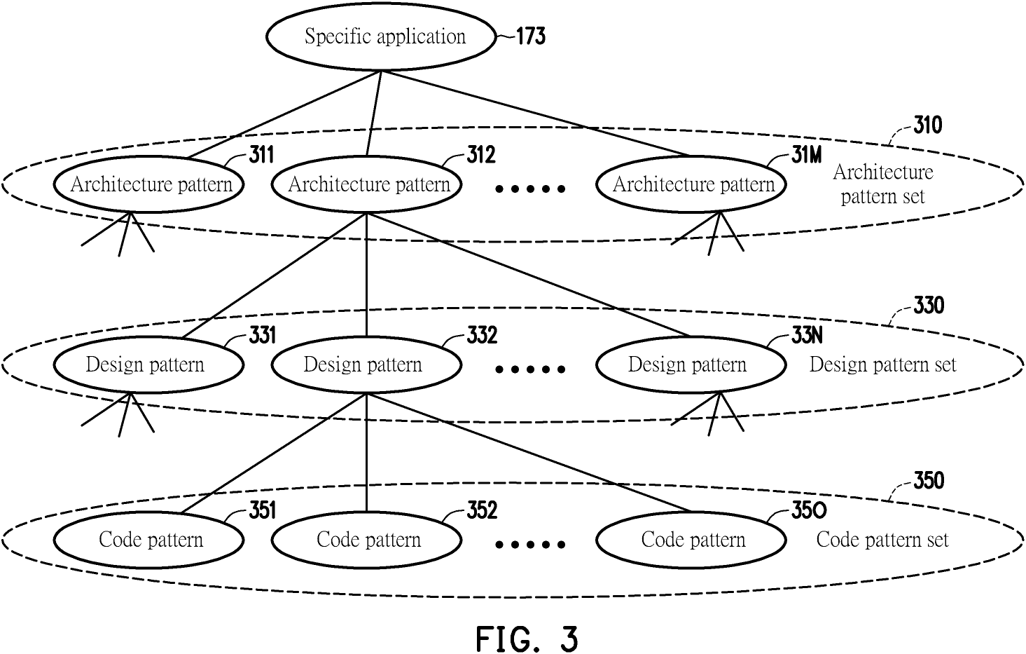

With reference to FIG. 3, which is a schematic diagram illustrating planning node sets of a plurality of planning layers according to an embodiment of the disclosure. In FIG. 3, the planning node set corresponding to the architecture layer is, for example, an architecture pattern set 310, and the architecture pattern set 310 includes a plurality of architecture patterns 311 to 31M (i.e., the planning nodes in the planning node set corresponding to the architecture layer). The planning node set corresponding to the design layer is, for example, a design pattern set 330, and the design pattern set 330 includes a plurality of design patterns 331 to 33N (i.e., the planning nodes in the planning node set corresponding to the design layer). The planning node set corresponding to the code layer is, for example, a code pattern set 350, and the code pattern set 350 includes a plurality of code patterns 351 to 350 (i.e., the planning nodes in the planning node set corresponding to the code layer).

In FIG. 3, one of the planning nodes (hereinafter referred to as a first planning node) of the i^{th} planning layer may correspond to multiple planning nodes (hereinafter referred to as second planning nodes) of an i+1^{th} planning layer. For instance, the architecture pattern 312 of the 1st planning layer (i.e., the architecture layer) may correspond to the design patterns 331 to 33N of the 2nd planning layer (i.e., the design layer). The design pattern 332 of the 2nd planning layer (i.e., the design layer) may correspond to the code patterns 351 to 350 of the 3rd planning layer (i.e., the code layer).

In an embodiment, the first planning node may satisfy a plurality of first preset conditions corresponding to the i^{th} planning layer. Further, all of the second planning nodes corresponding to the first planning node may satisfy a plurality of second preset conditions corresponding to the i+1^{th} layer, where i is a positive integer and N > i ≥ 1.

In an embodiment, the first preset conditions met by the first planning node may include that the planning node set of the i^{th} planning layer is not empty and may include meeting a requirement of the i^{th} planning layer. In an embodiment, the requirement of the i^{th} planning layer is determined based on a control flow graph, a data flow graph, a call graph, and a constraint condition graph, and content of the graphs may be determined by the designer according to needs.

Besides, the first preset conditions met by the first planning node further include achieving a metric of the i^{th} planning layer. In an embodiment, the planner 131 may obtain input data of the specific application 173 and estimates a fitness score corresponding to the i^{th} planning layer according to the input data. In an embodiment, the planner 131 may determine that the first planning node achieves the metric of the i^{th} planning layer in response to determining that the fitness score corresponding to the i^{th} planning layer is greater than a score threshold of the i^{th} planning layer; otherwise, the planner 131 may determine that the first planning node does not achieve the metric of the i^{th} planning layer.

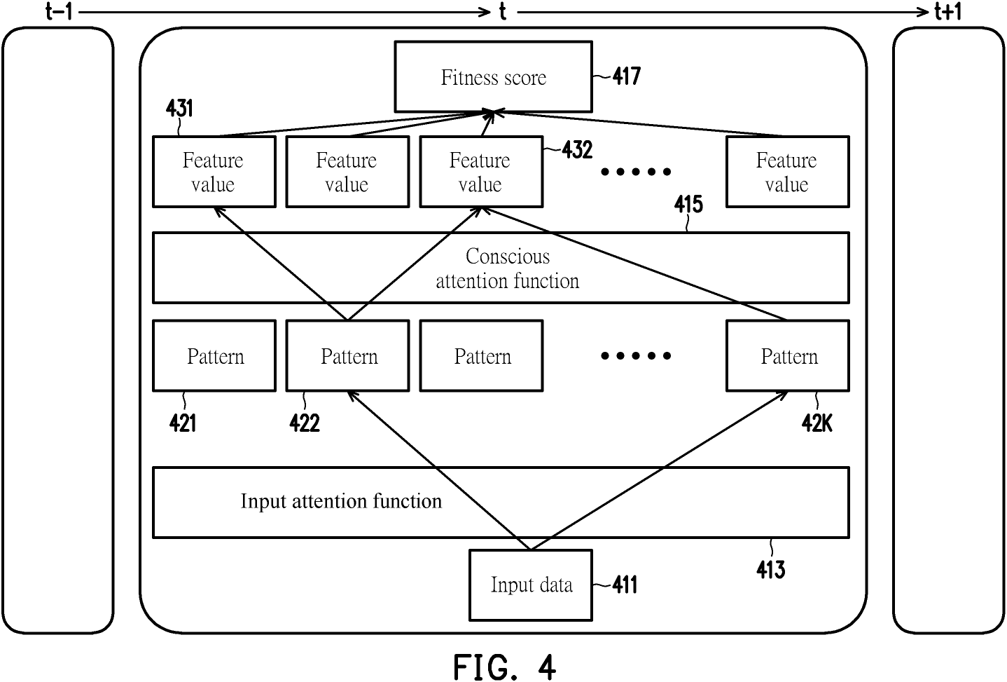

With reference to FIG. 4, which is a schematic diagram illustrating estimation of a fitness score corresponding to the i^{th} planning layer according to an embodiment of the disclosure. At a time point t in FIG. 4, the planner 131 may obtain input data 411 corresponding to the specific application 173. In different embodiments, a form of the input data 411 may vary according to a type of the specific application 173. For instance, it is assumed that the specific application 173 is a virtual reality application, and the input data 411 is, for example, related image data. Further, if the specific application 173 is a music player program, the input data 411 is, for example, a related audio file, but it is not limited thereto.

Next, the planner 131 may execute an input attention function 413 to find a plurality of reference patterns among a plurality of patterns 421 to 42K corresponding to the i^{th} planning layer in response to the input data 411. In an embodiment, it is assumed that the considered i^{th} planning layer is an architecture layer, each of the patterns 421 to 42K is then, for example, an architecture pattern. If the considered i^{th} planning layer is a design layer, each of the patterns 421 to 42K is, for example, a design pattern. If the considered i^{th} planning layer is a code layer, each of the patterns 421 to 42K is, for example, a code pattern, but it is not limited thereto.

In FIG. 4, it is assumed that the found reference patterns are the patterns 422 and 42K, the planner 131 may execute a conscious attention function 415 to find a plurality of feature values (e.g., feature values 431 and 432) corresponding to the reference patterns (i.e., reference patterns 422 and 42K). Next, the planner 131 may determine a fitness score 417 corresponding to the i^{th} planning layer based on the feature values 431 and 432, but it is not limited thereto.

In some embodiments, related details of FIG. 4 may be found with reference to “Goyal, A., Lamb, A., Hoffmann, J., Sodhani, S., Levine, S., Bengio, Y., & Schölkopf, B. (2021). Recurrent Independent Mechanisms. ArXiv, abs/1909.10893.”, and description thereof is not repeated herein.

In an embodiment, the first planning node may be understood as one of the first description sentences corresponding to the i^{th} description segment. In an embodiment, before executing action_i (adding/removing the first planning node, for example) corresponding to the first planning node, the planner 131 may determine whether all of the corresponding second planning nodes satisfy the second preset conditions corresponding to the i+1^{th} planning layer. In some embodiments, the second preset conditions may include that the planning node set corresponding to the i+1^{th} planning layer is not empty and may include meeting a requirement of the i+1^{th} planning layer and achieving a metric of the i+1^{th} planning layer. Details thereof may be found with reference to the description related to the requirement/metric of the i^{th} planning layer provided in the foregoing embodiments, and description thereof is thus not repeated herein.

In an embodiment, in response to determining that all of the second planning nodes corresponding to the first planning node satisfy the second preset conditions corresponding to the i+1^{th} layer, the planner 131 may execute action_i corresponding to the first planning node; otherwise, the planner 131 does not execute action_i corresponding to the first planning node. In other words, the planner 131 executes action i corresponding to the first planning node only when it is determined that all of the second planning nodes corresponding to the first planning node satisfy the second preset conditions in the i+1^{th} planning layer.

Taking FIG. 3 as an example, when the planner 131 determines whether to execute action_i corresponding to the architecture pattern 312, the planner 131 first determines whether all of the design patterns 331 to 33N corresponding to the architecture pattern 312 satisfy the corresponding preset conditions (e.g., whether satisfying the requirement of the design layer and whether achieving the metric of the design layer). Further, when the planner 131 determines whether to execute action_i corresponding to the design pattern 332, the planner 131 first determines whether all of the code patterns 351 to 350 corresponding to the design pattern 332 satisfy the corresponding preset conditions (e.g., whether satisfying the requirement of the code layer and whether achieving the metric of the code layer).

In other words, when the planner 131 determines that action i corresponding to the architecture pattern 312 is executed, it means that all of the patterns (including but not limited to the design patterns 331 to 33N and the code patterns 351 to 350) of other planning layers corresponding to the architecture pattern 312 meet the corresponding preset conditions.

In short, based on the content of the domain file F1, the planner 131 may generate the planning tree corresponding to each planning layer based on the above teaching.

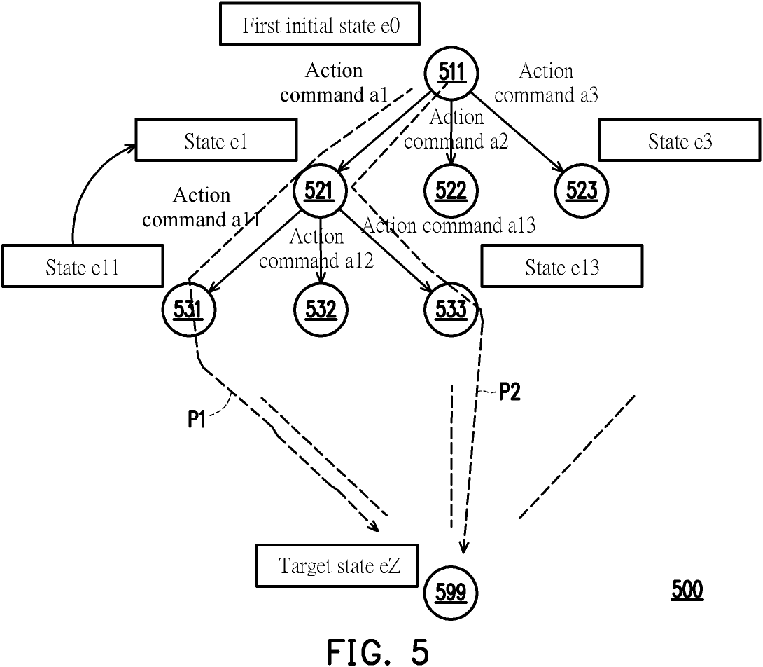

With reference to FIG. 5, which is a schematic diagram illustrating the planning tree corresponding to the code layer according to an embodiment of the disclosure. It should be understood that the planning trees corresponding to the architecture layer and the design layer also have a form similar to that provided in FIG. 5. However, in the embodiments of the disclosure, since only the operations in the code layer may have a substantial impact (for example, adding/deleting a piece of program code) on the program code of the specific application 173, a planning tree 500 corresponding to the code layer in FIG. 5 is taken as an example herein for illustration.

In FIG. 5, the planning tree 500 includes a plurality of state nodes 511 to 599. A state node 511 corresponds to, for example, a first initial state e0 of the code layer indicated by the problem file F2, and the state node 599 corresponds to, for example, a target state eZ of the code layer indicated by the problem file F2.

From FIG. 5, it can be seen that in the planning tree 500 established by the planner 131 according to the domain file F1, if an action command a1 is issued in the first initial state e0 corresponding to the state node 511, a state e1 corresponding to the state node 521 may be accordingly entered. If an action command a3 is issued in the first initial state e0 corresponding to the state node 511, a state e3 corresponding to the state node 523 may be accordingly entered. Further, if an action command a11 is issued in the state e1 corresponding to the state node 521, a state e11 corresponding to the state node 531 may be accordingly entered. If an action command a13 is issued in the state e1 corresponding to the state node 521, a state e13 corresponding to the state node 533 may be accordingly entered.

In an embodiment, after generating the planning tree for each of the planning layers, the planner 131 may execute step S230 to determine a first planning path in the state nodes of each of the planning trees based on a deep learning model.

Taking FIG. 5 as an example, after generating the planning tree 500, the planner 131 may determine the first planning path in the state nodes 511 to 599 of the planning tree 500 based on the deep learning model.

In an embodiment, regarding a specific state node (hereinafter referred to as a first state node) on the planning tree 500, the deep learning model selects one or a plurality of reference state nodes following the first state node among the state nodes 511 to 599 of the planning tree 500 based on an operation observation associated with the specific application 173 and a state of the first state node.

In FIG. 5, when the considered first state node is the state node 511, the deep learning model may select one or more reference state nodes following the first state node 511 among the state nodes 521 to 599 of the planning tree 500 based on the operation observation associated with the specific application 173 and the state e1 of the state node 511. In an embodiment, it is assumed that the deep learning model determines that the state nodes 521 and 522 are suitable to follow the state node 511 based on the operation observation of the specific application 173 and the state e1 of the state node 511, the deep learning model may then select the state nodes 521 and 522 as the reference state nodes following the state node 511, but it is not limited thereto.

In some embodiments, in order to enable the deep learning model to be equipped with the abovementioned capabilities, the deep learning model may be trained through a corresponding training process. In some embodiments, the training data used to train the learning model may be expressed as “what action command should be taken under a combination of a specific state and operation observation”. In an embodiment, this training data may be presented as “(observation, state) -> action”, but it is not limited thereto.

In this way, the deep learning model may learn which action command should be taken when a specific combination of state and operation observation is encountered. For instance, in the context of selecting the state nodes 521 and 522 as the reference state nodes following the state node 511, the deep learning model may be understood as determining that it is suitable to take the action command a1 or a2 under the combination of the current state (i.e., the first initial state e0) and operation observation, but it is not limited thereto.

Regarding each state node on the planning tree 500, the deep learning model may perform the operations taught above to select one or more reference state nodes corresponding to each state node. In this case, the planner 131 may connect each state node of the planning tree 500 to the corresponding one or more reference state nodes to form at least one candidate path in the planning tree 500. Herein, each candidate path may guide the i^{th} planning layer from the corresponding first initial state e0 to the corresponding target state eZ. Next, the planner 131 may treat one of the at least one candidate path of the planning tree 500 as the first planning path of the planning tree 500.

In FIG. 5, assuming that the planner 131 finds a total of candidate paths P1 and P2, and the candidate paths P1 and P2 may both guide the i^{th} planning layer from the corresponding first initial state e0 to the corresponding target state eZ. In this case, the planner 131 may select one of the candidate paths P1 and P2 as the first planning path of the planning tree 500.

In an embodiment, the planner 131 may select, for example, the one with a smaller number of hops (that is, the one containing fewer state nodes) from the candidate paths P1 and P2 as the first planning path of the planning tree 500. In other embodiments, the planner 131 may also set weights for the state nodes in the candidate paths P1 and P2 according to specific principles required by the designer, and then calculates a sum of the weights of the state nodes in the candidate paths P1 and P2. After that, the planner 131 may select the one with a larger (or smaller) sum of the weights from the candidate paths P1 and P2 as the first planning path of the planning tree 500, but it is not limited thereto.

In other embodiments, based on the teachings provided above, the planner 131 may find the corresponding first planning paths for the planning trees corresponding to the architecture layer and the design layer, so description of the details is not repeated herein.

In the embodiments of the disclosure, the planner 131 may also determine whether any of the action commands in the planning tree 500 is not successfully executed. In an embodiment, in response to determining that a first action command among the action commands in the planning tree 500 is not successfully executed, the planner 131 may return to a previous state and executes this first action command again until the first action command is successfully executed.

Taking FIG. 5 as an example, assuming that the planner 131 determines that the action command a11 cannot be successfully executed due to specific reasons (for example, the corresponding function/module of the specific application 173 cannot be accessed temporarily), so that the state e13 cannot be successfully entered. In this case, the planner 131 may return to the state e1 and try to issue the action command a11 again. If the action command a11 is still not successfully executed, the planner 131 may repeatedly execute the above actions until the action command a11 is successfully executed, but it is not limited thereto.

In step S240, the planner 131 generates a first scheduling plan Z03 according to a first planning path Z01 of a specific planning tree among the planning trees and sequentially issues a plurality of action commands A1 to AZ to the specific application 173 accordingly.

In the embodiments of the disclosure, since only the action commands corresponding to the code layer may have a substantial impact (for example, adding/deleting a piece of program code) on the program code of the specific application 173, the planner 131 may adopt the planning tree (e.g., planning tree 500 in FIG. 5) corresponding to the code layer to act as the considered specific planning tree, but it is not limited thereto.

In an embodiment, the first planning path Z01 of the specific planning tree is, for example, an unscheduled plan including the action commands A1 to AZ, that is, the action commands A1 to AZ have not yet been set with corresponding execution modes/execution time points. Taking FIG. 5 as an example, it is assumed that the candidate path P1 is selected as the first planning path Z01 of the planning tree 500, the action commands a1 and a11 included in the candidate path P1 (as well as other action commands included in the candidate path P1 that are not shown) may form the unscheduled plan of the planning tree 500, but it is not limited thereto.

After that, a scheduler 133 may assign a corresponding execution time point and an execution mode to each of the action commands A1 to AZ in the unscheduled plan (e.g., a first scheduling plan Z01) to generate the first scheduling plan Z03.

Next, the controller 15 may then sequentially issue the action commands A1 to AZ to the specific application 173 according to the execution time point of each of the action commands A1 to AZ in the first scheduling plan Z03. After that, the controller 15 may obtain an operation observation 01 generated by the specific application 173 in response to the first action command among the action commands A1 to AZ. For ease of description, the following assumes that the action command A1 is the considered first action command, but it is not limited thereto.

In an embodiment, after receiving the action commands A1 to AZ, the target system 171 may sequentially convert the action commands A1 to AZ into control commands C1 to CZ and may control the specific application 173 through the control commands C1 to CZ (such as adding/deleting a program code). In an embodiment, the specific application 173 may generate a corresponding operation event E1 in response to the control command C1 corresponding to the action command A1, which may be presented as a log or other types of files, for example. After that, the target system 171 may convert the operation event E1 into the operation observation O1 and provides the operation observation O1 to the controller 15.

In some embodiments, the operation of the specific application 173 may generate new technical requirements over time, which may make the first scheduling plan Z03 gradually inapplicable. Therefore, a replanning mechanism is provided in the disclosure to adaptively generate a new scheduling plan based on the operation of the specific application 173 in a timely manner.

In an embodiment, the controller 15 may convert the operation observation O1 of the specific application 173 into an execution state ES1, and the artificial intelligence planner 13 may determine whether the execution state ES1 indicates that a new scheduling plan needs is required to be generated. In an embodiment, the artificial intelligence planner 13 may make the above determination according to an application type of the specific application 173.

For instance, assuming that the target server 17 is an MEC server operating under the control of a core network of the fifth-generation communication system, the artificial intelligence planner 13 may then obtain the required big data (e.g., operation observation O1, execution state ES1, etc.) through a network data analytics function (NWDAF) of this core network, and then determines whether the relevant technical requirements have changed (e.g., the need for larger bandwidth/lower delay, etc.).

In an embodiment, in response to determining that the relevant technical requirements have changed, the artificial intelligence planner 13 may then determine that a new scheduling plan needs to be generated, and vice versa, it may determine that a new scheduling plan does not need to be generated, but it is not limited thereto.

In an embodiment, in response to determining that a new scheduling plan needs to be generated, the planner 131 determines a second initial state based on the execution state ES1 of the specific application 173 and determines a second planning path in the state nodes of each of the planning trees based on the deep learning model. Herein, the second planning path of each of the planning trees may guide the corresponding planning layer from the corresponding second initial state to the corresponding target state. Details thereof may be found with reference to the description of the determination of the first planning path for each planning tree made by the planner 131, and description thereof thus is not repeated herein.

After that, the scheduler 133 may generate a second scheduling plan according to the second planning path of the specific planning tree (e.g., planning tree 500) among the planning trees and sequentially issues a plurality of other action commands to the specific application 173 accordingly. Details thereof may be found with reference to the description of the determination of the first scheduling plan Z03 for the planning tree 500 made by the scheduler 133 according to the first planning path Z01 of the planning tree 500, and description thereof thus is not repeated herein.

It should be understood that although the above description of the replanning mechanism is directed to the specific application 173 having multiple planning layers (that is, N is greater than 1), in other embodiments, the replanning mechanism is also applicable to the specific application 173 having only a single planning layer (that is, N is 1).

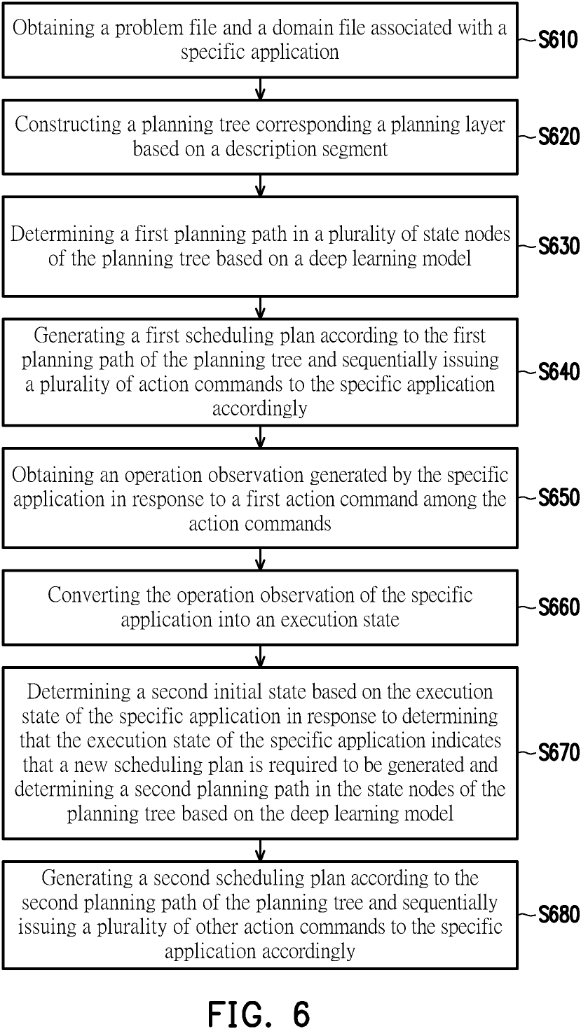

With reference to FIG. 6, which is a schematic flow chart illustrating an artificial intelligence planning method according to an embodiment of the disclosure. The method provided by this embodiment may be implemented by the artificial intelligence planner 13 of FIG. 1B executed by the processor 104 of FIG. 1A, and each step in FIG. 6 is described in detail together with the elements shown in FIG. 1B. In this embodiment, the steps shown herein may be applied to the specific application 173 having only a single planning layer (that is, N is 1), but it is not limited thereto.

First, in step S610, the planner 131 obtains the problem file F2 and the domain file F1 associated with the specific application 173. Herein, the domain file F1 includes a single description segment D1 of a single planning layer L1 corresponding to the specific application 173, and the problem file F2 indicates the first initial state and the target state of each of the single planning layer L1.

In step S620, the planner 131 constructs a planning tree T1 corresponding to the planning layer L1 based on the description segment D1, and the planning tree T1 has a plurality of state nodes.

In step S630, the planner 131 determines a first planning path PP1 in the state nodes of the planning tree T1 based on a deep learning model. Herein, the first planning path PP1 of the planning tree T1 guides the planning layer L1 from the corresponding first initial state to the corresponding target state.

In step S640, the scheduler 133 generates a first scheduling plan PL1 according to the first planning path PP1 of the planning tree T1, and the controller 15 sequentially issues a plurality of action commands AA1 to AAZ to the specific application 173 accordingly.

In step S650, the controller 15 obtains an operation observation O1a generated by the specific application 173 in response to a first action command among the action commands AA1 to AAZ.

In step S660, the controller 15 converts the operation observation O1a of the specific application 173 into an execution state ES1a.

In step S670, in response to determining that the execution state ES1a of the specific application 173 indicates that a new scheduling plan is required to be generated, the planner 131 determines a second initial state based on the execution state ES1a of the specific application 173 and determines a second planning path PP2 in the state nodes of the planning tree T1 based on the deep learning model. Herein, the second planning path PP2 of a planning tree T2 guides the planning layer L1 from the corresponding second initial state to the corresponding target state.

In step S680, the scheduler 133 generates a second scheduling plan PL2 according to the second planning path PP2 of the planning tree T2 and sequentially issues a plurality of other action commands to the specific application 173 accordingly. Details of the steps in FIG. 6 may be found with reference to the description provided in the foregoing embodiments, and description thereof is thus not repeated herein.

Based on the above, in the embodiments of the disclosure, in the case that the considered specific application has a plurality of planning layers (e.g., the architecture layer, design layer, code layer, etc.), the corresponding planning node set and the planning tree are established for each of the planning layers according to the domain file, and all of the planning nodes in the planning node set of each of the planning layers satisfy the corresponding preset conditions. In addition, in the embodiments of the disclosure, a corresponding planning path may be determined in each of the planning trees, and a plurality of action commands may be accordingly issued to the specific application to achieve the corresponding target state. In this way, the specific application having multiple planning layers may be equipped with self-configuration, self-optimizing, and self-healing functions and is then implemented as a self-organizing application.

In some embodiments, the disclosure further provides implementation of arrangement of a real-time open radio access network (RAN) intelligent controller (RT RIC) in an open RAN (O-RAN) architecture, and description is provided in detail as follows.

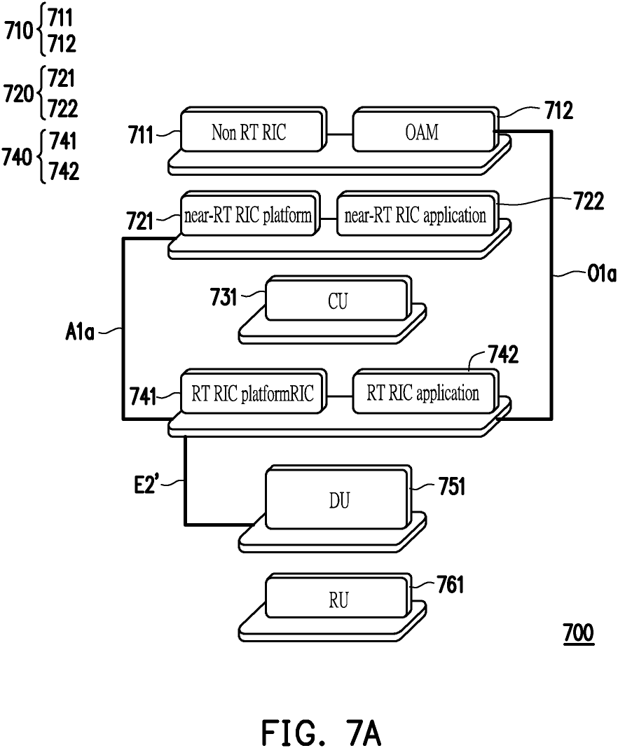

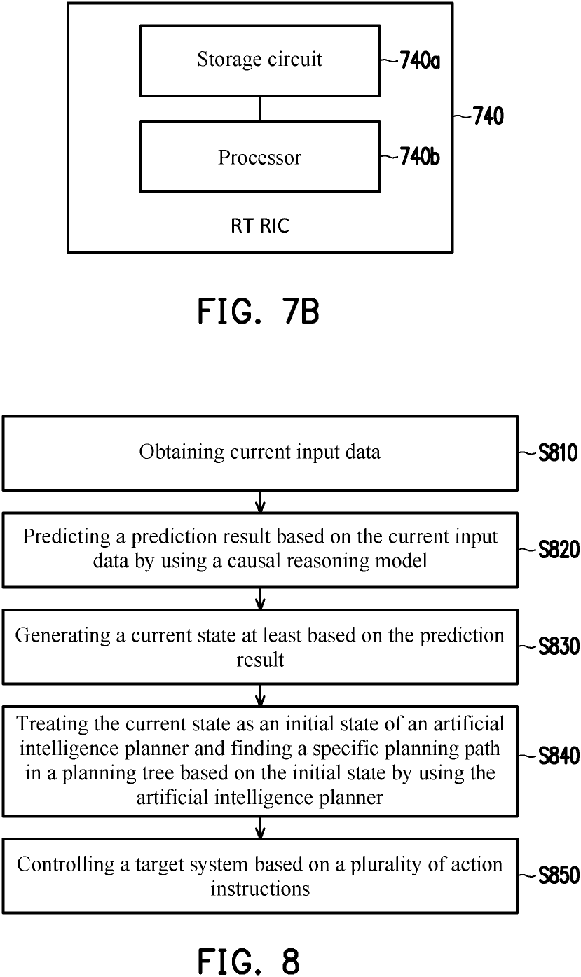

With reference to FIG. 7A and FIG. 7B, FIG. 7A is a schematic diagram illustrating an O-RAN architecture according to an embodiment of the disclosure, and FIG. 7B is a schematic diagram illustrating a RT RIC according to FIG. 7A. In FIG. 7A, an O-RAN architecture 700 includes a non-RT RIC 711, an operations, administration, and maintenance, (OAM) entity 712, a near-RT RIC platform 721, a near-RT RIC application 722, a central unit (CU) 731, a RT RIC platform 741, a RT RIC application 742, a distributed unit (DU) 751, and a radio unit (RU) 761. Features of the CU 731, the DU 751, and the RU 761, may be found with reference to the description in the relevant O-RAN specifications, and description thereof is thus not repeated herein.

In the embodiments of the disclosure, the RT RIC platform 741 and RT RIC application 742 may be integrated into a RT RIC 740, and the artificial intelligence planning device 100 in FIG. 1A may be configured to implement the RT RIC 740 or be disposed in the RT RIC 740. In addition, various programs/modules (e.g., the policy maker 11, the planner 131, the scheduler 133, the controller, etc.) running on the artificial intelligence planning device 100 may be understood to correspond to one or more RT RIC applications 742, but are not limited thereto.

In FIG. 7B, the RT RIC 740 may include a storage circuit 740a and a processor 740b coupled to each other. Implementation of the storage circuit 740a and the processor 740b may be found with reference to that of the storage circuit 102 and the processor 104, and description thereof is not repeated herein.

In FIG. 7A, the non-RT RIC 711 and the OAM entity 712 may be integrated into a service management and orchestration (SMO) platform 710, and the near-RT RIC platform 721 and the near-RT RIC application 722 may be integrated into a near-RT RIC 720.

In 7A, in response to the RT RIC 740 configured in the embodiments of the disclosure, the O-RAN architecture 700 is further provided with an interface for the RT RIC 740 to communicate with other components/units/entities. For instance, a fronthaul configuration interface A1a is configured between the RT RIC 740 and the near-RT RIC 720, and the RT RIC 740 may receive a fronthaul configuration from the near-RT RIC 720 through the fronthaul configuration interface A1a. In an embodiment, the RT RIC 740 may optimize a fronthaul configuration based on the abovementioned fronthaul configuration, but it is not limited thereto.

In addition, an OAM interface O1a is disposed between the RT RIC 740 and (the OAM entity 712 of) the SMO platform 710, and the RT RIC 740 may receive a fault, configuration, accounting, performance, and security (FCAPS) configuration from the OAM entity 712 through the OAM interface O1a, but it is not limited thereto.

Besides, a real-time control interface E2′ is disposed between the RT RIC 740 and the DU 751. In an embodiment, when the artificial intelligence planning device 100 is disposed on the RT RIC 740, the DU 751 may be implemented as the target system 171 in FIG. 1B. In this case, the RT RIC 740 may control the DU 751 (i.e., the target system 171) based on the action commands A1 to AZ through the real-time control interface E2′, but it is not limited thereto.

In an embodiment, the real-time control interface E2′ may use a user datagram protocol (UDP). In an embodiment, the RT RIC 740 may be placed only a few meters away from the DU 751 or may be integrated into the same device/server together with the DU 751. In this case, low-latency real-time data transmission with a low packet loss rate may be achieved by using the UDP for data exchange on the real-time control interface E2′.

In an embodiment, the non-RT RIC 711 may send a trained model or a plurality of trained models (at least one of a structured causal model (SCM) and a causal reasoning model to be described later) to the near-RT RIC 720. In an embodiment, the non-RT RIC 711 may perform the abovementioned data transmission through an A1 interface (not shown) between the non-RT RIC 711 and the near-RT RIC 720. Related description of the A1 interface may be found with reference to the specification documents related to O-RAN.

In an embodiment, the near-RT RIC 720 may perform incremental training on a model from the non-RT RIC 711 and deploy the incrementally-trained model to the RT RIC 740 through the fronthaul configuration interface A1a. In an embodiment, after receiving a policy from the non-RT RIC 711 through the A1 interface, the near-RT RIC 720 may deploy the policy to the RT RIC 740 through the fronthaul configuration interface A1a.

In an embodiment, the near-RT RIC 720 may receive enrichment information from the non-RT RIC 711 through the A1 interface, and the near-RT RIC 720 may augment the enrichment information and treats the augmented enrichment information as the fronthaul configuration and deploy the fronthaul configuration to the RT RIC 740 through the fronthaul configuration interface A1a.

In an embodiment, the near-RT RIC 720 may use the augmented enrichment information to incrementally train the model from the non-RT RIC 711 or to test the model deployed onto the RT RIC 740.

In the embodiments of the disclosure, the RT RIC 740 may generate an initial state for (the artificial intelligence planner 13 of) the artificial intelligence planning device 100 to perform artificial intelligence planning based on a specific method, and then accordingly determines the action command (e.g., DU 751) for controlling the target system 171. Further description is provided as follows.

With reference to FIG. 8, which is a schematic flow chart illustrating an artificial intelligence planning method according to an embodiment of the disclosure. The method provided by this embodiment may be executed by the RT RIC 740, and each step in FIG. 8 is described in detail together with the elements shown in FIG. 7A and FIG. 7B.

Further, in order to make the concept of the disclosure easier to understand, the following takes bandwidth calendaring for the RU 761 as a hypothetical application scenario, but the disclosure may not be limited thereto. In this application scenario, it is assumed that the RT RIC 740 is configured for booking a bandwidth of the RU 761 in one or more time periods (e.g., periods of time in a day).

First, in step S810, the processor 740b obtains current input data. In different embodiments, the current input data may be various data obtained at the moment, and the type/composition may be different according to the considered application situation. For instance, in the context of bandwidth calendaring for the RU 761, the current input data is, for example, a data traffic currently occurring on the RU 761, but it is not limited thereto.

Next, in step S820, the processor 740b predicts a prediction result based on the current input data by using a causal reasoning model.

In the bandwidth calendaring concept of the disclosure, at least three manners are provided for bandwidth booking. Manner 1: A user specifies to book the bandwidth of one or more specified time periods in the abovementioned time period (hereinafter referred to as a first bandwidth booking situation). For instance, the user specifies the bandwidth from 10:00 am to 12:00 am on a booked date A. Manner 2: A network operator (operator) books the bandwidth of one or more unspecified time periods in the abovementioned time period (hereinafter referred to as a second bandwidth booking situation). For instance, the network operator may book any four hours of the booked date A, but the RT RIC 740 may decide which four hours of the date A to allocate to the network operator. Manner 3: The RT RIC 740 predicts that relevant bandwidth requirements may occur in one or more time periods in the abovementioned time period, and then pre-books the bandwidth (hereinafter referred to as a predicted bandwidth usage situation). For instance, there may be a large demand for bandwidth usage during specific periods of an e-commerce promotion day, so the RT RIC 740 may book the bandwidth for these periods after making relevant predictions, but it is not limited thereto.

Based on the above, in step S820, the processor 740b may be configured to determine the predicted bandwidth usage situation to act as the prediction result.

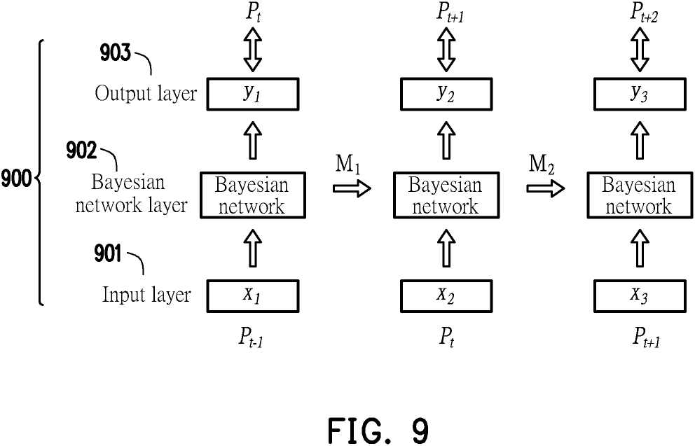

With reference to FIG. 9, which is a schematic diagram illustrating generation of a prediction result according to an embodiment of the disclosure. In FIG. 9, a causal reasoning model 900 is a recurrent Bayesian network, and the recurrent Bayesian network includes an input layer 901, a Bayesian network layer 902, and an output layer 903. In an embodiment, the causal reasoning model may be understood as a model in which a hidden layer in the recurrent neural network is replaced by the Bayesian network layer 902, and the concept of the Bayesian network may be found with reference to related description provided by the related art.

In FIG. 9, at a t-1^{th} time point, the processor 740b may obtain current input data X₁ at the t-1^{th} (t is an index value) time point. The Bayesian network layer 902 then generates an output feature vector y₁ and a probability vector M₁ corresponding to the t-1^{th} time point at least based on the current input data X₁ at the t-1^{th} time point. In an embodiment, the Bayesian network layer 902 may generate the output feature vector y₁ and the probability vector M₁ corresponding to the t-1^{th} time point based on a prediction result Pₜ₋₁ based on a t-2^{th} time point and the current input data X₁ at the t-1^{th} time point.

Next, the processor 740b may generate a prediction result Pt corresponding to t-1^{th} time point based on the output feature vector y₁ corresponding to the t-1^{th} time point. In an embodiment, the processor 740b may feed the output feature vector y₁ into a classifier, so that the classifier determines a label corresponding to the output feature vector y₁ as the prediction result Pₜ, but it is not limited thereto.

At a t^{th} time point, the processor 740b may obtain current input data X₂ at the t^{th} time point. The Bayesian network layer 902 then generates an output feature vector y₂ and a probability vector M₂ corresponding to the t^{th} time point at least based on the current input data X₂ at the t^{th} time point and the probability vector M₁ outputted by the Bayesian network layer at the t-1^{th} time point. In an embodiment, the Bayesian network layer 902 may generate the output feature vector y₂ and the probability vector M₂ corresponding to the t^{th} time point based on the prediction result Pt based on the t-1^{th} time point, the current input data X₂ at the t^{th} time point, and the probability vector M₁ outputted by the Bayesian network layer 902 at the t-1^{th} time point.

Next, the processor 740b may generate a prediction result Pₜ₊₁ corresponding to t^{th} time point based on the output feature vector y₂ corresponding to the t^{th} time point. In an embodiment, the processor 740b may feed the output feature vector y₂ into the classifier, so that the classifier determines a label corresponding to the output feature vector y₂ as the prediction result Pₜ₊₁, but it is not limited thereto.

At a t+1^{th} time point, the processor 740b may obtain current input data X₃ at the t+1^{th} time point. The Bayesian network layer 902 then generates an output feature vector y₃ and a probability vector (not additionally marked) corresponding to the t+1^{th} time point at least based on the current input data X₃ at the 1+1^{th} time point and the probability vector M₂ outputted by the Bayesian network layer at the t^{th} time point. In an embodiment, the Bayesian network layer 902 may generate the output feature vector y₃ and the probability vector corresponding to the t+1^{th} time point based on the prediction result Pₜ₊₁ based on the t^{th} time point, the current input data X₃ at the t+1^{th} time point, and the probability vector M₂ outputted by the Bayesian network layer 902 at the t^{th} time point.

Next, the processor 740b may generate a prediction result Pₜ₊₂ corresponding to t+1^{th} time point based on the output feature vector y₃ corresponding to the t+1^{th} time point. In an embodiment, the processor 740b may feed the output feature vector y₃ into the classifier, so that the classifier determines a label corresponding to the output feature vector y₃ as the prediction result Pₜ₊₂, but it is not limited thereto.

Based on the teaching provided above, the processor 740b may obtain the prediction result corresponding to any time point (e.g., the predicted bandwidth usage situation), but it is not limited thereto. In the embodiment of bandwidth calendaring for the RU 761, the above operation may be understood as predicting the relevant predicted bandwidth usage based on the data traffic on the RU 761 through the causal reasoning model 900.

In step S830, the processor 740b generates a current state CS at least based on the prediction result. In an embodiment, the processor 740b may combine the above prediction results with one or more given results as the current state CS. In an embodiment, the given result includes, for example, at least one of the first bandwidth booking situation and the second bandwidth booking situation. In other words, in different embodiments, the processor 740b may arbitrarily combine the above prediction results, the first bandwidth booking situation, and the second bandwidth booking situation as the current state CS, but it is not limited thereto.

In step S840, the processor 740b treats the current state CS as an initial state of the artificial intelligence planner 13 and finds a specific planning path in a planning tree based on the initial state by using the artificial intelligence planner 13.

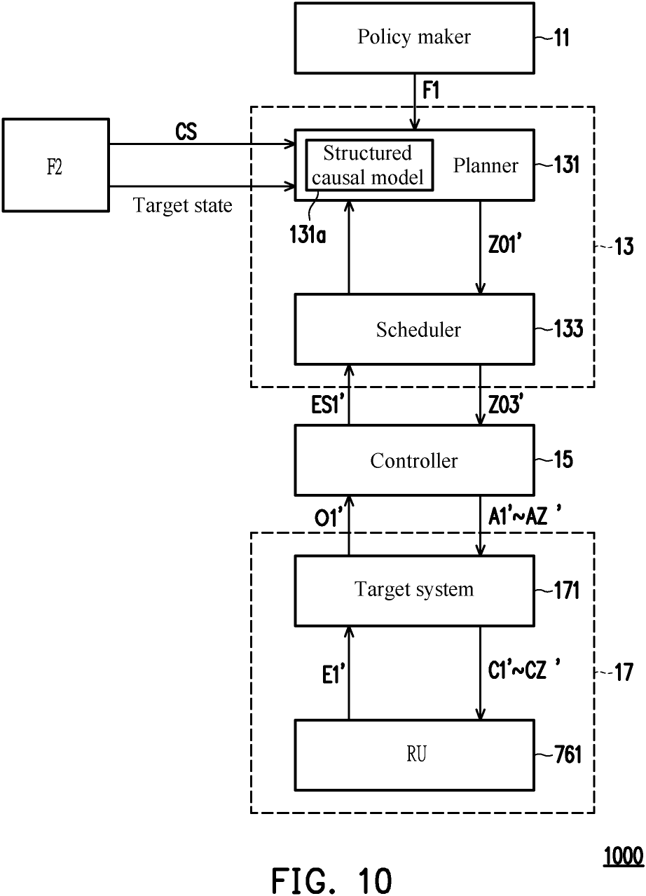

With reference to FIG. 10, which is a schematic diagram illustrating bandwidth calendaring for a RU according to FIG. 1B. In FIG. 10, the planner 131 may obtain the current state CS as the initial state and constructs a corresponding planning tree based on the domain file F1. The planning tree may include a plurality corresponding state nodes. Related description of the construction of the planning tree may be found with reference to the foregoing embodiments, and description thereof is thus not provided herein.

In FIG. 10, the planner 131 may include a structured causal model 131a. In an embodiment, for a first state node on the planning tree, the structured causal model 131a may select one or a plurality of reference state nodes following the first state node among the state nodes of the planning tree based on a plurality of environmental variables and a state of the first state node.

Further, compared with the method of determining the reference state node following each state node by the deep learning model as provided in the previous embodiments, the structured causal model 131a is used instead in this embodiment to determine the reference state node following each state node.

In some embodiments, in order to enable the structured causal model 131a to be equipped with the abovementioned capabilities, the structured causal model 131a may be trained through a corresponding training process. In some embodiments, the training data used to train the structured causal model 131a may be expressed as “what action command should be taken under a specific combination of environmental variables”. In an embodiment, each training data may be presented as “(e_1, e_2, ..., e_n, state)->action” (e_1, e_2, ..., e_n represent the considered environmental variables), but it is not limited thereto.

In this way, the structured causal model 131a may learn which action command should be taken when a specific combination of state and environmental variables is encountered.

In an embodiment, assuming that the planning tree considered by the processor 740b in step S840 is the planning tree 500 in FIG. 5, in the scenario in which the state nodes 521 and 522 are selected as the reference state nodes following the state node 511, the structured causal model 131a may be understood as determining that it is suitable to take the action command a1 or a2 under the combination of the current state (i.e., the first initial state e0) and environmental variables, but it is not limited thereto.

In an embodiment, assuming that the processor 740b in step S830 determines that the current state CS is the state e1 in FIG. 5, in the scenario in which the state nodes 531 to 533 are selected as the reference state nodes following the state node 521, the structured causal model 131a may be understood as determining that it is suitable to take the action command a11, a12, and/or a13 under the combination of the current state (i.e., the state e1) and environmental variables, but it is not limited thereto.

In different embodiments, different factors may be selected as environmental variables, such as seasons/special offer/emergency conditions (power outages, etc.), but it is not limited thereto.

In an embodiment, the structured causal model 131 may obtain one or plural reference state nodes corresponding to each of the state nodes of the planning tree according to the above teaching and connects each of the state nodes of the planning tree and the corresponding one or plural reference state nodes to form one or a plurality of candidate paths in the planning tree. Each of the candidate paths may be connected from the initial state (i.e., the current state) to the target state.

Next, the planner 131 may treat one of the one or plural candidate paths of the planning tree as a specific planning path Z01′ of the planning tree. This specific planning path Z01′ includes a plurality of action instructions A1′ to AZʹ. In this embodiment, the method of determining the specific planning path Z01′ may be found with reference to the method of determining the planning tree 500 as provided in the foregoing embodiments, and description thereof is thus not provided herein.

Next, in step S850, the processor 740b controls a target system 1710 (e.g., DU 751) based on the action instructions A1′ to AZ′.

In an embodiment, the specific planning path Z01′ includes, for example, an unscheduled plan of the action instructions A1′ to AZ′. In an embodiment, the scheduler 133 may assign a corresponding execution time point and an execution mode to each of the action commands A1′ to AZ′ in the unscheduled plan to generate a scheduling plan Z03′. Next, the controller 15 may sequentially issue the action commands A1′ to AZ′ to the target system 1710 according to the execution time point of each of the action commands A1′ to AZ′.

In an embodiment, after receiving the action commands A1′ to AZ′, the target system 1710 (e.g., DU 751) may sequentially convert the action commands A1′ to AZ′ into control commands C1′ to CZ′ and may control the RU 761 through the control commands C1′ to CZ′. In an embodiment, the processor 740b may request the target system 1710 (e.g., the DU 751) to control the RU 761 to book one or a plurality of bandwidths in one or a plurality of time periods for bandwidth calendaring.

In an embodiment, the RU 761 may generate a corresponding operation event E1 in response to the control command C1′ corresponding to the action command A1′, which may be presented as a log or other types of files, for example. After that, the target system 1710 (e.g., DU 751) may convert the operation event E1′1 into operation observation O1′ and provides the operation observation O1′ to the controller 15.

In an embodiment, the controller 15 may convert the operation observation O1′ of the RU 761 into an execution state ES1′, and the artificial intelligence planner 13 may determine whether the execution state ES1′ indicates that a new scheduling plan is required to be generated. Related details may be found with reference to the description provided in the foregoing embodiments, and description thereof is thus not repeated herein.

In view of the foregoing, in the embodiments of the disclosure, the concept of arrangement of the RT RIC in the O-RAN architecture is provided, and the manner of data exchange between the RT RIC and other units/entities (e.g., near-RT RIC, DU, etc.) is given. In this way, data exchange between the RT RIC and other units/entities may be achieved with low latency.

In addition, in the embodiments of the disclosure, the artificial intelligence planning method implemented on the RT RIC is also provided. In the embodiments of the disclosure, after obtaining the prediction result by using the causal reasoning model, the RT RIC may generate the current state based on the prediction result and/or the given result and treats this current state as the initial state considered by the artificial intelligence planner when planning the specific planning path on the planning tree. The RT RIC may then accordingly control the target system (e.g., control the DU to issue a command to the RU) based on the plurality of action instructions included in the specific planning path.

Applications running on the RT RIC may support RT RIC applications such as policy-based traffic steering (through the fronthaul configuration interface and/or real-time control interface) and bandwidth calendaring. Since the fifth-generation communication systems operate at fast speeds, the reduction in latency may save much bandwidth sold to end users.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An artificial intelligence planning method, comprising:
obtaining current input data;
predicting a prediction result based on the current input data by using a causal reasoning model;
generating a current state at least based on the prediction result;
treating the current state as an initial state of an artificial intelligence planner and finding a specific planning path in a planning tree based on the initial state by using the artificial intelligence planner, wherein the specific planning path comprises a plurality of action instructions; and
controlling a target system based on the action instructions.

2. The method according to claim 1, wherein the causal reasoning model is a recurrent Bayesian network, and the recurrent Bayesian network comprises an input layer, a Bayesian network layer, and an output layer, wherein the step of predicting the prediction result by using the causal reasoning model based on the current input data further comprises:
obtaining the current input data at a t^{th} time point, wherein t is an index value;
generating, by the Bayesian network layer, an output feature vector and a probability vector corresponding to the t^{th} time point at least based on the current input data at the t^{th} time point and a probability vector outputted by the Bayesian network layer at a t-1^{th} time point; and
generating the prediction result corresponding to t^{th} time point based on the output feature vector corresponding to the t^{th} time point.

3. The method according to claim 2, wherein the step of generating, by the Bayesian network layer, the output feature vector and the probability vector corresponding to the t^{th} time point at least based on the current input data at the t^{th} time point and the probability vector outputted by the Bayesian network layer at the t-1^{th} time point further comprises:
generating, by the Bayesian network layer, the output feature vector and the probability vector corresponding to the t^{th} time point based on the prediction result based on the t-1^{th} time point, the current input data at the t^{th} time point, and the probability vector outputted by the Bayesian network layer at the t-1^{th} time point.

4. The method according to claim 1, wherein the step of generating the current state at least based on the prediction result further comprises:
combining the prediction result with at least one given result to act as the current state.

5. The method according to claim 4, wherein the prediction result comprises at least one predicted bandwidth usage situation in at least one time period, and the at least one given result comprises a first bandwidth booking situation and a second bandwidth booking situation, wherein the first bandwidth booking situation comprises a bandwidth booking situation for at least one first specified time period in the at least one time period, and the second bandwidth booking situation comprises a bandwidth booking situation for at least one first unspecified time period in the at least one time period.

6. The method according to claim 1, wherein the target system comprises a distributed unit, and the step of controlling the target system based on the action instructions further comprises:
requesting the distributed unit to control a radio unit to book at least one bandwidth in at least one time period.

7. The method according to claim 1, wherein the artificial intelligence planner comprises a structured causal model, and the planning tree comprises a plurality of state nodes, and the step of finding the specific planning path in the planning tree by using the artificial intelligence planner based on the initial state further comprises:
for a first state node on the planning tree, selecting, by the structured causal model, at least one reference state node following the first state node among the state nodes of the planning tree based on a plurality of environmental variables and a state of the first state node;
obtaining the at least one reference state node corresponding to each of the state nodes of the planning tree and connecting each of the state nodes of the planning tree and the corresponding at least one reference state node to form at least one candidate path in the planning tree, wherein each of the at least one candidate path is connected from the initial state to a target state; and
treating one of the at least one candidate path of the planning tree as the specific planning path of the planning tree.

8. The method according to claim 1, wherein the specific planning path of the planning tree comprises an unscheduled plan of the action instructions, and the step of controlling the target system based on the action instructions further comprises:
assigning, by a scheduler, a corresponding execution time point and an execution mode to each of the action commands in the unscheduled plan to generate a scheduling plan; and
sequentially issuing the action commands to the target system according to the execution time point of each of the action commands.

9. The method according to claim 1, wherein the method is implemented by a real-time radio access network (RAN) intelligence controller, and the method further comprises:
receiving, by the real-time radio access network intelligence controller, a fronthaul configuration from a near real-time radio access network intelligence controller through a fronthaul configuration interface; and
receiving, by the real-time radio access network intelligence controller, a fault, configuration, accounting, performance, and security (FCAPS) configuration from a service management and orchestration (SMO) platform through an operations, administration, and maintenance (OAM) interface.

10. The method according to claim 9, wherein the fronthaul configuration comprises at least one of a structured causal model and the causal reasoning model running in the artificial intelligence planner.

11. The method according to claim 9, wherein the fronthaul configuration comprises enrichment information augmented and deployed by the near real-time radio access network intelligence controller.

12. The method according to claim 1, wherein the method is implemented by a real-time radio access network (RAN) intelligence controller, and the method further comprises:
controlling, by the real-time radio access network intelligence controller, the target system based on the action instructions through a real-time control interface.

13. The method according to claim 12, wherein the real-time control interface uses a user datagram protocol (UDP).

14. A real-time radio access network intelligence controller, comprising:
a non-transitory storage circuit, storing a program code; and
a processor, coupled to the non-transitory storage circuit, accessing the program code for:
obtaining current input data;
predicting a prediction result based on the current input data by using a causal reasoning model;
generating a current state at least based on the prediction result;
treating the current state as an initial state of an artificial intelligence planner and finding a specific planning path in a planning tree based on the initial state by using the artificial intelligence planner, wherein the specific planning path comprises a plurality of action instructions; and
controlling a target system based on the action instructions.

15. The real-time radio access network intelligence controller according to claim 14, wherein the causal reasoning model is a recurrent Bayesian network, and the recurrent Bayesian network comprises an input layer, a Bayesian network layer, and an output layer, wherein the processor is configured for:
obtaining the current input data at a t^{th} time point, wherein t is an index value;
generating, by the Bayesian network layer, an output feature vector and a probability vector corresponding to the t^{th} time point at least based on the current input data at the t^{th} time point and a probability vector outputted by the Bayesian network layer at a t-1^{th} time point; and
generating the prediction result corresponding to t^{th} time point based on the output feature vector corresponding to the t^{th} time point.

16. The real-time radio access network intelligence controller according to claim 15, wherein the processor is configured for:
generating, by the Bayesian network layer, the output feature vector and the probability vector corresponding to the t^{th} time point based on the prediction result based on the t-1^{th} time point, the current input data at the t^{th} time point, and the probability vector outputted by the Bayesian network layer at the t-1^{th} time point.

17. The real-time radio access network intelligence controller according to claim 14, wherein the processor is configured for:
combining the prediction result with at least one given result to act as the current state.

18. The real-time radio access network intelligence controller according to claim 14, wherein the target system comprises a distributed unit, and the processor is configured for:
requesting the distributed unit to control a radio unit to book at least one bandwidth in at least one time period.

19. The real-time radio access network intelligence controller according to claim 14, wherein the artificial intelligence planner comprises a structured causal model, and the planning tree comprises a plurality of state nodes, and the processor is configured for:
for a first state node on the planning tree, selecting, by the structured causal model, at least one reference state node following the first state node among the state nodes of the planning tree based on a plurality of environmental variables and a state of the first state node;
obtaining the at least one reference state node corresponding to each of the state nodes of the planning tree and connecting each of the state nodes of the planning tree and the corresponding at least one reference state node to form at least one candidate path in the planning tree, wherein each of the at least one candidate path is connected from the initial state to a target state; and
treating one of the at least one candidate path of the planning tree as the specific planning path of the planning tree.

20. The real-time radio access network intelligence controller according to claim 14, wherein the specific planning path of the planning tree comprises an unscheduled plan of the action instructions, and the processor is configured for:
assigning, by a scheduler, a corresponding execution time point and an execution mode to each of the action commands in the unscheduled plan to generate a scheduling plan; and
sequentially issuing the action commands to the target system according to the execution time point of each of the action commands.
